(19) United States
(12) Patent Application Publication
(10) Pub. No.: US 2002/0113739 A1
(43) Pub. Date: Aug. 22, 2002

(54) Arrayed-segment loop antenna

(76) Inventor: David Amundson Howard, Newark, CA (US)

Correspondence Address: DAVID E LOVEJOY, 4 EMBARCADERO CENTER, SUITE 400, SAN FRANCISCO, CA, 941114156

(21) Appl. No.: 09/738,906

(22) Filed: Dec. 14, 2000

(51) Int. Cl. H01Q 1/24; H01Q 11/12; H01Q 7/00

(52) U.S. Cl. 343/702; 343/741; 343/866

(57) ABSTRACT

A segmented loop antenna formed of many segments connected in an electrical loop where the segments are arrayed in multiple divergent directions that tend to increase the antenna electrical length while permitting the overall outside antenna dimensions to fit within the antenna areas of communication devices. The loop antenna operates in a communication device to exchange energy at a radiation frequency and includes a connection having first and second conductors for conduction of electrical current in a radiation loop. The radiation loop includes a plurality of electrically conducting segments each having a segment length. The segments are connected in series electrically connected between said first and second conductors for exchange of energy at the radiation frequency. The loop has an electrical length, A, that is proportional to the sum of segment lengths for each of said radiation segments and the segments are arrayed in a pattern so that different segments connect at vertices and conduct electrical current in different directions near the vertices.

### BACKGROUND OF THE INVENTION

The present invention relates to the field of communication devices that communicate using radiation of electromagnetic energy through antennas and particularly relates to portable phones, pagers and other telephonic devices.

Personal communication devices, when in use, are usually located close to an ear or other part of the human body. Accordingly, use of personal communication devices subjects the human body to radiation. The radiation absorption from a personal communication device is measured by the rate of energy absorbed per unit body mass and this measure is known as the specific absorption rate (SAR). Antennas for personal communication devices are designed to have low peak SAR values so as to avoid absorption of unacceptable levels of energy, and the resultant localized heating by the body.

For personal communication devices, the human body is located in the near-field of an antenna where much of the electromagnetic energy is reactive and electrostatic rather than radiated. Consequently, it is believed that the dominant cause of high SAR for personal communication devices is from reactance and electric field energy of the near field. Accordingly, the reactance and electrostatic fields of personal communication devices need to be controlled to minimize SAR.

Antennas Generally.

In personal communication devices and other electronic devices, antennas are elements having the primary function of transferring energy to or from the electronic device through radiation. Energy is transferred from the electronic device into space or is received from space into the electronic device. A transmitting antenna is a structure that forms a transition between guided waves contained within the electronic device and space waves traveling in space external to the electronic device. A receiving antenna is a structure that forms a transition between space waves traveling external to the electronic device and guided waves contained within the electronic device. Often the same antenna operates both to receive and transmit radiation energy.

J. D. Kraus “Electromagnetics”, 4th ed., McGraw-Hill, New York 1991, Chapter 15 Antennas and Radiation indicates that antennas are designed to radiate (or receive) energy. Antennas act as the transition between space and circuitry. They convert photons to electrons or vice versa. Regardless of antenna type, all involve the same basic principal that radiation is produced by accelerated (or decelerated) charge. The basic equation of radiation may be expressed as follows:

IL=Qν(Am/s)

where:

I=time changing current (A/s)

L=length of current element (m)

Q=charge (C)

ν=time-change of velocity which equals the acceleration of the charge (m/s)

The radiation is perpendicular to the direction of acceleration and the radiated power is proportional to the square of IL or Qν.

A radiated wave from or to an antenna is distributed in space in many spatial directions. The time it takes for the spatial wave to travel over a distance r into space between an antenna point, Pₐ, at the antenna and a space point, Pₛ, at a distance r from the antenna point is r/c seconds where r=distance (meters) and c=free space velocity of light (=3×10⁸ meters/sec). The quantity r/c is the propagation time for the radiation wave between the antenna point Pₐ and the space point Pₛ.

An analysis of the radiation at a point Pₛ at a time t, at a distance r caused by an electrical current I in any infinitesimally short segment at point Pₐ of an antenna is a function of the electrical current that occurred at an earlier time [t−r/c] in that short antenna segment. The time [t−r/c] is a retardation time that accounts for the time it takes to propagate a wave from the antenna point Pₐ at the antenna segment over the distance r to the space point Pₛ.

Antennas are typically analyzed as a connection of infinitesimally short radiating antenna segments and the accumulated effect of radiation from the antenna as a whole is analyzed by accumulating the radiation effects of each antenna segment. The radiation at different distances from each antenna segment, such as at any space point Pₛ, is determined by accumulating the effects from each antenna segment of the antenna at the space point Pₛ. The analysis at each space point Pₛ is mathematically complex because the parameters for each segment of the antenna may be different. For example, among other parameters, the frequency phase of the electrical current in each antenna segment and distance from each antenna segment to the space point Pₛ can be different.

A resonant frequency, ƒ, of an antenna can have many different values as a function, for example, of dielectric constant of material surrounding antenna, the type of antenna and the speed of light.

In general, wave-length, λ, is given by λ=c/ƒ=cT where c=velocity of light (=3×10⁸ meters/sec), ƒ=frequency (cycles/sec), T=1/ƒ=period (sec). Typically, the antenna dimensions such as antenna length, Aₜ, relate to the radiation wavelength λ of the antenna.

The electrical impedance properties of an antenna are allocated between a radiation resistance, Rᵣ, and an ohmic resistance, Rₒ. The higher the ratio of the radiation resistance, Rᵣ, to the ohmic resistance, Rₒ the greater the radiation efficiency of the antenna.

Antennas are frequently analyzed with respect to the near field and the far field where the far field is at locations of space points Pₛ where the amplitude relationships of the fields approach a fixed relationship and the relative angular distribution of the field becomes independent of the distance from the antenna.

Antenna Types.

A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. Small antennas, including loop antennas, often have the property that radiation resistance, Rᵣ, of the antenna decreases sharply when the antenna length is shortened. Small loops and short dipoles typically exhibit radiation patterns of 1/2λ and 1/4λ, respectively. Ohmic losses due to the ohmic resistance, Rₒ are minimized using impedance matching networks. Although impedance matched small loop antennas can exhibit 50% to 85% efficiencies, their bandwidths have been narrow, with very high Q, for example, Q>50. Q is often defined as (transmitted or received frequency)/(3 dB bandwidth).

An antenna goes into resonance where the impedance of the antenna is purely resistive and the reactive component is 0. Impedance is a complex number consisting of real resistance and imaginary reactance components. A matching network forces a resonance by eliminating the reactive component of impedance for a particular frequency.

Antennas based upon more complex shapes have also been proposed. For example, U.S. Pat. No. 6,104,349 to Cohen and entitled TUNING FRACTAL ANTENNAS AND FRACTAL RESONATORS describes dipole antennas based upon deterministic fractals. Fractals are patterns based upon a plurality of connected segments. Fractal patterns are categorized as random fractals (which are also termed chaotic or Brownian fractals) or deterministic fractals. A deterministic fractal is a self-similar structure that results from the repetition of a design (sometimes called a “motif” or “generator”).

Low SAR Antennas.

Antenna design involves tradeoffs between antenna parameters including gain, size, efficiency, bandwidth and SAR. When antennas are employed in personal communication devices, size is of paramount importance since the antenna must not be physically obtrusive to the user and SAR must be low to minimize local heating in the body of users.

U.S. Pat. No. 5,784,032 to Johnston et al entitled COMPACT DIVERSITY ANTENNA WITH WEAK BACK NEAR FIELD described three-dimensional antennas with multiple diversity interconnected loops that are described as having weak near fields. However, three-dimensional antennas are somewhat difficult to design into the physical enclosure of compact personal communication devices while still obtaining acceptable parameter values.

In consideration of the above background, there is a need for improved antenna designs that achieve the objectives of low values of SAR, physical compactness suitable for personal communication devices and other acceptable antenna design parameters.

### SUMMARY

The present invention is a segmented loop antenna formed of many segments connected in an electrical loop where the segments are arrayed in multiple divergent directions that tend to increase the antenna electrical length while permitting the overall outside antenna dimensions to fit within the antenna areas of communication devices.

The loop antenna operates in a communication device to exchange energy at a radiation frequency and includes a connection having first and second conductors for conduction of electrical current in a radiation loop. The radiation loop includes a plurality of electrically conducting segments each having a segment length. The segments are connected in series electrically connected between said first and second conductors for exchange of energy at the radiation frequency. The loop has an electrical length, Aₜ that is proportional to the sum of segment lengths for each of said radiation segments and the segments are arrayed in a pattern so that different segments connect at vertices and conduct electrical current in different directions near the vertices.

The arrayed segments that form the loop antenna may be straight or curved and of any lengths. Collectively the arrayed segments appreciable increase antenna electrical lengths while permitting the antenna to fit within the available area of communicating devices. The pattern formed by the antenna segments may be regular and repeating or may be irregular and non-repeating. Mathematically, the pattern of the arrayed-segment loop antenna may be expressed as a continuous function or as a discontinuous function with one or more, and frequently many, directional discontinuities that collectively increase the antenna electrical length while maintaining overall external dimensions of the loop antenna.

The electrical length of the arrayed-segment loop antenna is typically equal to the wavelength, λ, or integral multiples thereof, of the radiation wave from the antenna. Although the antenna's electrical length is not small compared to λ, the near field in reactive and electrical fields tend to be low whereby the SAR for the arrayed-segment loop antenna tends to be low.

The arrayed-segment loop antennas are typically located internal to the housings of personal communicating devices where they tend to be less immune to de-tuning due to objects in the near field in close proximity to the personal communicating devices.

The foregoing and other objects, features and advantages of the invention will be apparent from the following detailed description in conjunction with the drawings.

### BRIEF DESCRIPTION OF THE DRAWINGS

FIG. 1 depicts a wireless communication unit showing by broken line the location of an antenna area.

FIG. 2 depicts a schematic, cross-sectional end view of the FIG. 1 communication unit.

FIG. 3 depicts a top view of a loop antenna with a saw-tooth shaped antenna superimposed over an equivalent-length circular loop antenna, each with matching transmission line feeds.

FIG. 4 depicts a top view an irregular-shaped loop antenna.

FIG. 5 depicts a top view a loop antenna with a bi-level slat rectangular-tooth shaped antenna within a circle having a perimeter equal to the physical length of the antenna.

FIG. 6 depicts a top view of one slat of the antenna of FIG. 5.

FIG. 7A depicts a top view of an irregular-shaped segmented loop antenna having a length of about 337 mm.

FIG. 7B depicts a top view of an irregular-shaped segmented loop antenna like that of FIG. 7A with a length of about 150 mm.

FIG. 8 depicts a cross-sectional view of a segment along the section line 8-8″ of FIG. 7A.

FIG. 9A depicts a top view of a round loop antenna having a length of about 337 mm with a transmission line matching element.

FIG. 9B depicts a top view of a round loop antenna on a substrate having a length of about 150 mm connected to a transmission line matching element.

FIG. 9C depicts a top view of an octagon loop antenna having a length of about 150 mm together with a Q-section transmission line matching element.

FIG. 10A depicts a top view of a snowflake-shaped loop antenna having a radiation length of about 337 mm together with a transmission line matching element.

FIG. 10B depicts a top view of a snowflake-shaped loop antenna having a radiation length of about 150 mm together with a transmission line matching element.

FIG. 11A depicts a top view of a reduced segment count simplified snowflake-shaped loop antenna having a radiation length of about 337 mm together with a transmission line matching element.

FIG. 11B depicts a top view of a reduced segment count snowflake-shaped loop antenna having a radiation length of about 150 mm together with a transmission line matching element.

FIG. 11C depicts a top view of a reduced segment count snowflake-shaped loop antenna having a radiation length of about 150 mm together with contact elements.

FIG. 12A depicts a top view of a koch island fractal-shaped loop antenna having a radiation length of about 337 mm together with a transmission line matching element.

FIG. 12B depicts a top view of a koch island fractal-shaped loop antenna having a radiation length of about 150 mm together with a transmission line matching element.

FIG. 13 depicts a the device of FIG. 1 juxtaposed a person's head at the ear.

FIG. 14 depicts the components of the device of FIG. 1.

FIG. 15 depicts a perspective view of a 2-D representation of the far field data (in elevation along the Y-axis) for, and superimposed over, the arrayed-segment antenna of FIG. 9C.

FIG. 16 depicts a perspective view of a 2-D representation of the far field data (in elevation along the Y-axis) for, and superimposed over, the arrayed-segment antenna of FIG. 12B.

FIG. 17 depicts a perspective view of a 3-D representation of the far field data (in elevation along the Y-axis) for the arrayed-segment antenna of FIG. 9C.

FIG. 18 depicts a perspective view of a 3-D representation of the far field data (in elevation along the Y-axis) for the arrayed-segment antenna of FIG. 12B.

FIG. 19 depicts a view of a 2-D representation of a slice of the FIG. 17 data in the YZ-plane.

FIG. 20 depicts a view of a 2-D representation of a slice of the FIG. 18 data in the YZ-plane.

FIG. 21 depicts a perspective view of a 2-D representation of the far field data (in the XₚZₚ-plane) for, and superimposed over, the arrayed-segment antenna of FIG. 9C.

FIG. 22 depicts a perspective view of a 2-D representation of the far field data (in the XₚZₚ-plane) for, and superimposed over, the arrayed-segment antenna of FIG. 12B.

FIG. 23 depicts a perspective view of a 3-D representation of the far field data (in the XₚY-plane highlighted) for the arrayed-segment antenna of FIG. 9C.

FIG. 24 depicts a perspective view of a 2-D representation of the far field data (in the XₚY-plane highlighted) for the arrayed-segment antenna of FIG. 12B

FIG. 25 depicts a view of a 2-D representation of the far field data of FIG. 23.

FIG. 26 depicts a view of a 2-D representation of the far field data of FIG. 24.

FIG. 27 depicts a graph of the measured far field strength for the antennas of FIG. 9B and FIG. 11B.

FIG. 28 depicts a top view of an antenna having two or more antenna loops on a common substrate.

### DETAILED DESCRIPTION

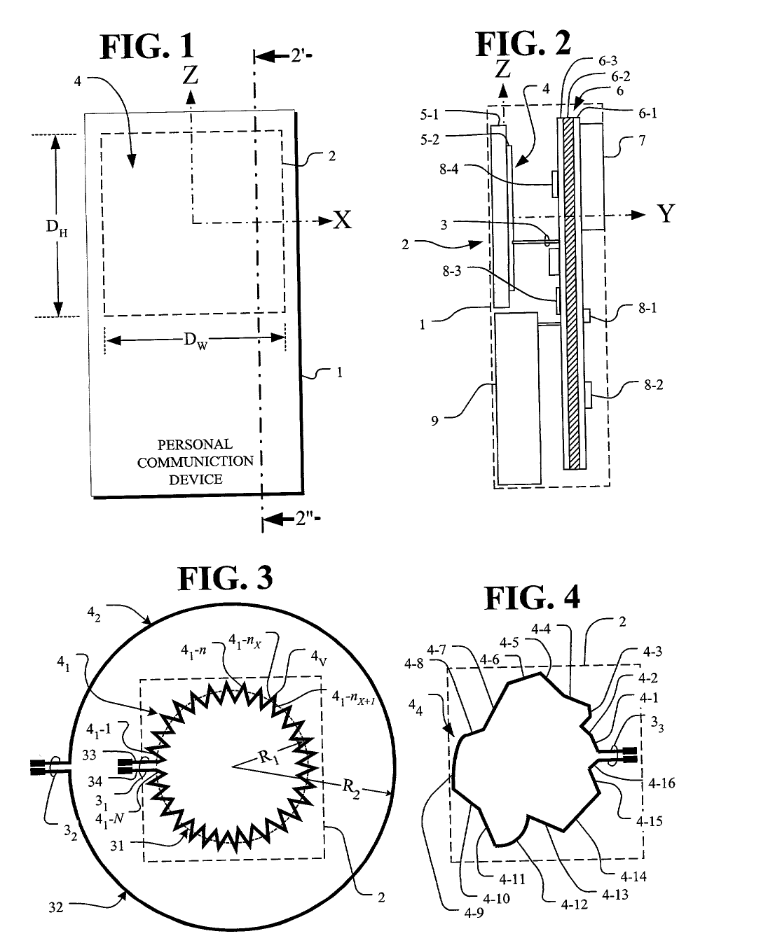

In FIG. 1, personal communication device 1 is a cell phone, pager or other similar communication device that can be used in close proximity to people. The communication device 1 includes an antenna area 2 for receiving an antenna 4 which receives and/or transmits radio wave radiation from and to the personal communication device 1. In FIG. 1, the antenna area 2 has a width D_{W} and a height D_{H}. A section line 2′-2″ extends from top to bottom of the personal communication device 1.

In FIG. 2, the personal communication device 1 of FIG. 1 is shown in a schematic, cross-sectional, end view taken along the section line 2′-2″ of FIG. 1. In FIG. 2, a printed circuit board 6 includes, by way of example, one conducting layer 6-1, an insulating layer 6-2 and another conducting layer 6-3. The printed circuit board 6 supports the electronic components associated with the communication device 1 including a display 7 and miscellaneous components 8-1, 8-2, 8-3 and 8-4 which are shown as typical. Communication device 1 also includes a battery 9. The antenna assembly 5 includes a substrate 5-1 and a conductive layer 5-2 that forms a loop antenna 4 offset from the printed circuit board 6 by a gap which tends to suppress coupling between the antenna layer 5-2 and the printed circuit board 6. The conductive layer 5-2 is connected to printed circuit board 6 by a coaxial conductor 3. The antenna 4 of FIG. 1 and FIG. 2 is an arrayed-segment loop antenna that has small area so as to fit within the antenna area 2, has acceptably low SAR and exhibits good performance in transmitting and receiving signals.

In FIG. 3, a illustrative antenna 4₁, described for analysis purposes, has segments arrayed in a circular sawtooth pattern connected electrically in series and connected by coaxial line 3₁ to form a loop antenna. The arrayed sawtooth segments of the loop antenna 4₁ fall generally symmetrically on a circle 31 of radius R₁ that fits within the antenna area 2, which has been allocated for an antenna, in the communication device 1 of FIG. 1. The antenna 4₁ has an actual enclosed area, λ(R₁)² and has an electrical length, Aₜ₌₁ of π(2R₂) where λ(2R₂) is significantly longer than the circumference π(2R₁) of the circle 31.

In FIG. 3, the antenna 4₂ represents antenna 4₁ when the antenna 4₁ has been stretched-out to a circle having a maximum enclosed area, π(R₂)². The antenna 4₂ has a coaxial transmission line 3₂ having first and second conductors. The circle formed by antenna 4₂ is a virtual circle for antenna 4₁. The superimposed maximum enclosed area, π(R₂)² of the antenna 4₂ is a virtual maximum area for antenna 4₁ over a circle of radius R₁. The loop antenna 4₂ has a radius R₂ that is approximately twice the radius R₁ and has an electrical length, Aₜ₌₂ of π(2R₂) which is the same as the electrical length of antenna 4₁. Accordingly, although the antenna 4₂ and antenna 4₁ have the same electrical length, the actual enclosed area of antenna 4₁ is much smaller than the maximum area enclosed by of antenna 4₂. FIG. 3 represents an example of a loop antenna 4₂, having a given electrical length, Aₜ, arrayed in a simple plain geometry (in the present example, a circle 32) that does not fit within a designated antenna area 2. The antenna 4₂ can be converted to an arrayed segment antenna 4₁ having the same given electrical length, Aₜ, but with an actual enclosed area small enough to fit within the designated antenna area 2.

When the FIG. 3 antenna 4₁ is used for communication devices, the wavelength, λ, for one or more of the resonant frequencies of interest are such that, for efficient antenna design, the electrical length, Aₜ, cannot be made small with respect to λ. For this reason, it cannot be assumed for analytical simplicity (as is done for analysis of “small loop” antennas) that the electrical current, i, in the loop of antenna 4₁ is in phase when representing the energy fields as a function of location and direction for antenna 4₁. Accordingly, the analytical models for showing the fields of the arrayed-segmented antennas is mathematically complex even when the arrayed-segment loop antenna has a high degree of symmetry as in antenna 4₁. Even more difficulty of analysis arises when arrayed-segment antennas are irregular, that is, have segment patterns that are arrayed without a high degree of symmetry.

In FIG. 3, the transmission line 3, is a connection means formed of first and second conductors 33 and 34 for non-radiating conduction of electrical current between the circuit board 6 of FIG. 2 and the loop 4₁. The loop 4, has a plurality of electrically conducting radiation segments 4₁-1, . . . , 4₁-n, . . . , 4₁-N each having a segment length. The segments 4₁-1, . . . , 4₁-n, . . . , 4₁-N are connected at vertices and in series to form a loop electrically connected between the first and second conductors 33 and 34 of the transmission line. The loop 4₁ has an electrical length, Aₜ, that is proportional to the sum of segment lengths for each of the radiation segments 4₁-1, . . . , 4₁-n, . . . , 4₁-N so as to facilitate an exchange of energy at the radiation frequency.

The radiation segments 4₁-1, . . . , 4₁-n, . . . , 4₁-N are arrayed in a sawtooth pattern that tends to juxtapose in close proximity first ones of the segments 4₁-nₓ conducting electrical current with a component in one direction to a vertices 4v with second ones of the segments 4₁-nₓ₊₁ conducing electrical current at an acute angle in another direction from the vertices 4₁. Accordingly, the different segments of antenna 4₁ connect at vertices and conduct electrical current in different directions near said vertices.

The loop antenna 4₁ of FIG. 3 is represented by a virtual circle of radius R₂ having a perimeter length equal to π(2R₂) that defines a virtual maximum enclosed area of n(R₂)². The segments 4₁-1, . . . , 4₁-n, . . . , 4₁-N are arrayed in a pattern that has an enclosed area of n(R₁)² that is represented by circle 31 of perimeter equal to π(2R₁) that defines a virtual enclosed area of Tu(R₁)² where R, is substantially less than R₂ and the virtual enclosed area of (R₁)² is substantially less than the virtual maximum enclosed area of T(R₁)² but where the electrical length electrical length, Aₜ, of the loop antenna 4₁ is approximately equal to 90 (2R₂).

In FIG. 4, an irregular-shaped arrayed-segment loop antenna 4₄ is formed of an array of line segments 4-1, 4-2, . . . , 4-16 connected in electrical series. The loop antenna 4₄ includes a coaxial connector 3₃ to complete formation of the loop antenna. The loop antenna 4₄ fits within the antenna area 2. The segments of the antenna 4₄ included straight and curved lines and are arrayed without any particular symmetry. The segments of loop antenna 4₄ of FIG. 4 include straight line segments such as 4-1 and 4-2 and include curved line segments such as 4-9 and 4-12. The area of the loop antenna 4₄ fits within the antenna area 2 designated for the communication device 1 of FIG. 1.

In FIG. 5, an arrayed-segment loop antenna 45, with equivalent radius R₁, is shown fitting within the antenna area 2 of the communication device 1 of FIG. 1. The arrayed-segment loop antenna 4₅ is formed of twenty-four slats 66 symmetrically arrayed about a circle of radius R₁. The slats 66 are paired with alternating pairs, such as pairs 67₁ and 67₂, of length shorter and longer than an average radius R₁. Therefore, for loop antenna 4₅, the actual enclosed area is π(R₁)². For loop antenna 4₅, the virtual maximum enclosed area (that is, the area that would-be enclosed by the antenna 4₅ if stretched out to a circle with a radius of R₂) would not fit within the antenna area 2 of the communication device 1 of FIG. 1. In FIG. 5, the loop antenna 4₅ lies in the XZ-plane which is the plane of the paper and the Y-plane is normal to the XZ-plane and extends out of the paper. The antenna 4₅ has an actual enclosed area, π(R₁)² and has an electrical length, Aₜ₌₁ of π(2R₂) where π(2R₂) is significantly longer than the circumference π(2R₁).

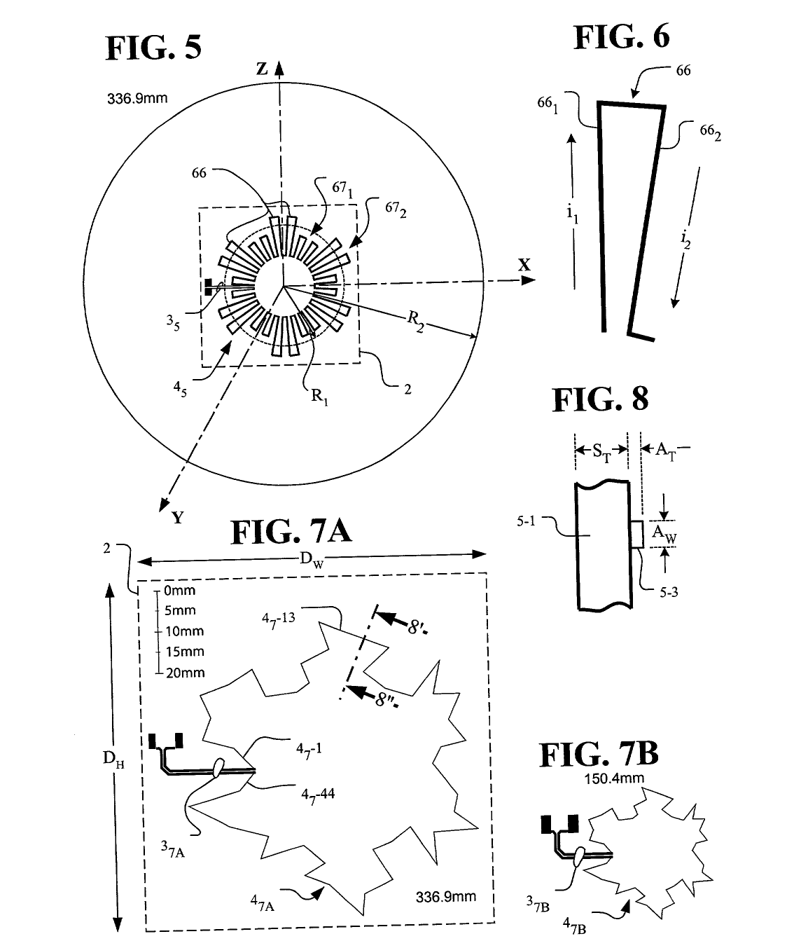

In FIG. 6, one tooth 66, typical of the of the slats 66 of antenna 4₅ of FIG. 5, has a leg 66₁ that conducts electrical current i₁ in one direction (generally positive Z-axis direction) and another leg 66₂ that conducts electrical current i₂ in the opposite direction (generally, negative Z-axis direction). The loop 4₅ has symmetry resulting from alternating short and long regions, such as by slats 67₁ and 67₂, of FIG. 5. In FIG. 6, the E field generated by the segment 66₁ can be compared with the E field generated by the segment 66₂ in the near field normal to the YZ-plane along the X axis. Additionally, the E fields of the short slats, such as slats 67₁, can be compared with the E fields of the long slats, such as slats 67₂, whether side by side or across the diameter of the circle with radius R₁. However, the analysis of fields, even for simple geometries, is difficult. Reference is made to the book, ANTENNAS, by John D. Kraus, Second Addition, CHAPTER 10, SELF AND MUTUAL IMPEDANCES where analysis for short segments of simple geometries is given. Not withstanding the complexity of segment by segment E field analysis, the objective is to array the segments such that the net E field generated in the near field of the antenna is small. Antenna patterns that are effective in having acceptable E field patterns are shown in FIG. 7A through FIG. 12B.

In FIG. 7A, an irregular-shaped arrayed-segment loop antenna 4_{7A} is formed of array of line segments 4₇-1, 4₇-2, . . . , 4₇-44, connected in electrical series and connected to an element 3_{7A}. The

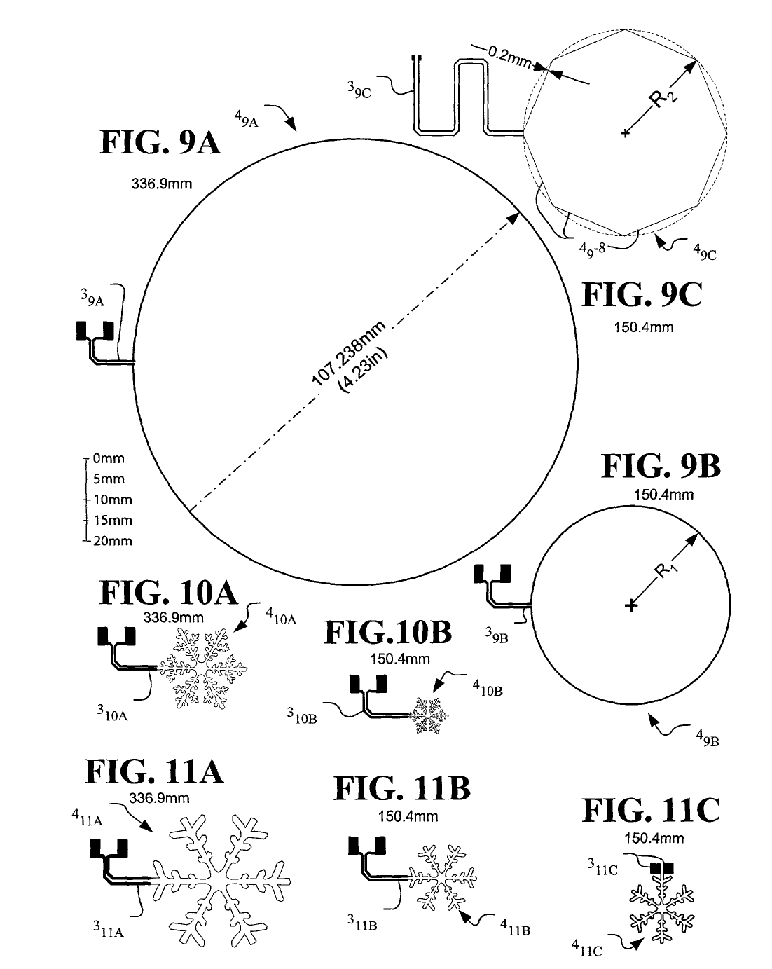

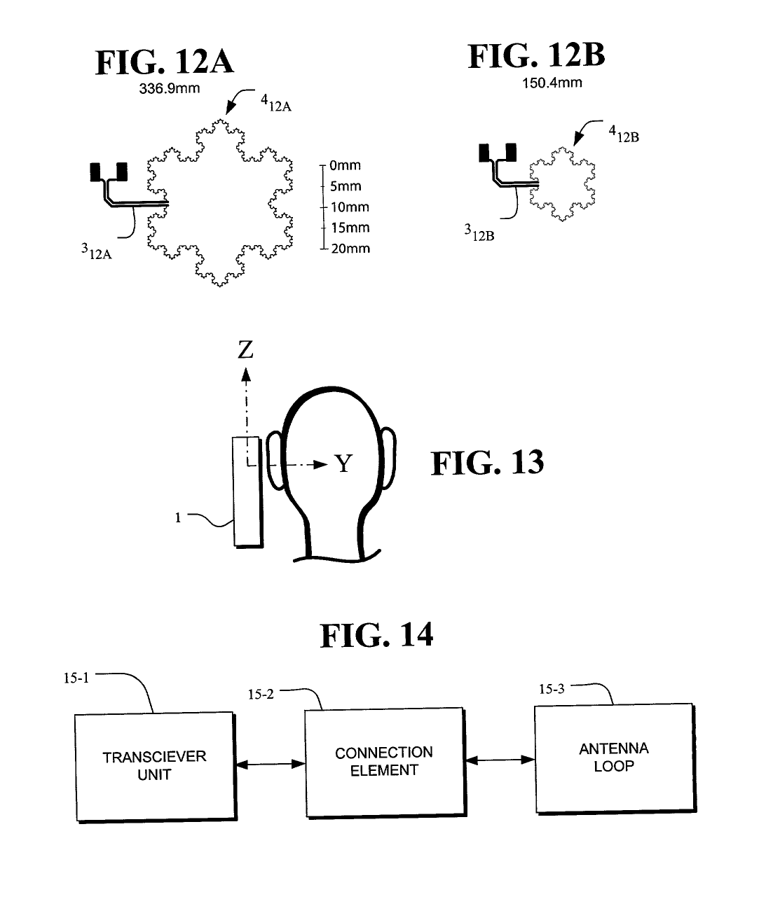

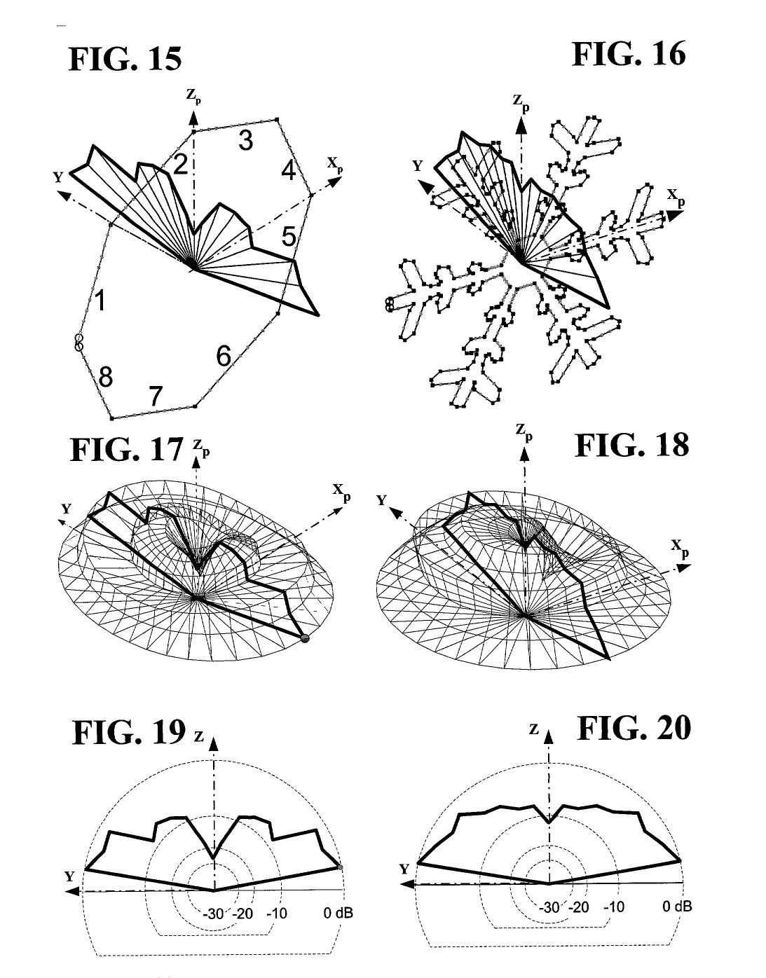

FIG. 9A depicts a top view of a round loop antenna 4_{9A} having a length of about 337 mm and a transmission line matching element 3_{9A}. The antenna 4_{9A} is drawn approximately to scale and has a diameter of approximately 107.238 mm (4.23 inch) that does not fit within the antenna area 2 of FIG. 1 typical of smaller handheld wireless devices such as portable phones and accordingly is only suitable for use with larger devices. The antenna 4_{9A} is designed for a frequency of 837 MHz and has a physical length of approximately 336.9 mm and is combined with the antenna leads, or equivalent matching element 3_{9A}. The properties of the antenna leads and/or the matching network are determined, among other things, based upon the conductors and material of the antenna substrate as discussed in connection with FIG. 8. The antenna of FIG. 9A is, therefore, designed for operation at the center of the US Cellular mobile transmit band.

FIG. 9B depicts a top view of a round loop antenna 4_{9B} having a length of about 150 mm and having a transmission line matching element 3_{9B}. The antenna 4_{9B} is designed for a frequency of approximately 1900 MHz and has a physical length of approximately 150 mm and is combined with the antenna leads, or equivalent matching network 3_{9B}. The antenna 4_{9B} is, therefore, designed for operation at the center of the US PCS band.

FIG. 9C depicts a top view of an octagon loop antenna 4_{9C} having a length of about 150 mm and having a Q-section transmission line matching element 3_{9C}. The radius, R₂ of the circle in which the octagon antenna of FIG. 9C is inscribed is equal to about 1.026R, where R, is the radius of the circle antenna of FIG. 9B using the formula for the perimeter, Pₙ, of an n-sided regular polygon inscribed in a circle of radius R₂, Pₙ=2nR₂sin(T/n). The antennas of FIGS. 9B and 9C have the same physical length of 150 mm, R, equals 150/7 mm and R₂ equals (1.026)(150/n)mm. The Q-section matching element 3_{9C} is drawn to scale for matching the antenna loop segments 4₉-8 impedance to 50 ohms. The antenna loop segments 4₉-8 have an impedance of about 130 ohms and the matching element 3_{9C} has an impedance of 80 ohms. Combining the impedance of the segments 4₉-8 with the impedance of the matching element 3_{9C} results in the octagon loop antenna 4_{9C} having an impedance of 50 ohms. The calculation of the Q-section matching element impedance, Zₛ, uses the impedance, Z_{L}, of the antenna loop (130 ohms in FIG. 9C), the impedance, Z₀, of the transceiver (50 ohms, see transceiver 15-1 in FIG. 14). The impedance Zₛ is the square root of the product of Z_{L} Z₀ which has a length equal to the 1/4 wavelength of the resonant frequency. While a Q-section matching element has been described, numerous other matching elements are well known. For example, a series section, transformers and other such devices.

FIG. 10A depicts a top view of a snowflake-shaped loop antenna 4_{10A} having a radiation length of about 337 mm which is the same length as the length of the FIG. 9A antenna. The antenna 4_{10A} has a transmission line matching element 3_{10A} which is not necessarily drawn to scale for matching the impedance of the antenna loop. The different segments of antenna 4_{10A} connect at vertices and conduct electrical current in different directions near said vertices.

FIG. 10B depicts a top view of a snowflake-shaped loop antenna 4_{10B} having a radiation length of about 150 mm which is the same length as the length of the FIG. 9B and FIG. 9C antennas. The antenna 4_{10B} has a transmission line matching element 3_{10B} which is not necessarily drawn to scale for matching the impedance of the antenna loop. The antenna 4_{10A} has a transmission line matching element 3_{10A} which is not necessarily drawn to scale for matching the impedance of the antenna loop. The different segments of antenna 4_{10B} connect at vertices and conduct electrical current in different directions near said vertices.

The scale of the FIG. 10A and FIG. 10B antennas in the drawing is the same as the scale of the antennas of FIG. 9A, FIG. 9B and FIG. 9C. Note that the areas of the FIG. 10A and FIG. 10B antennas are substantially smaller than the areas of the FIG. 10A and FIG. 10B antennas. The arrayed-segment loop antenna 4_{10A}, excluding the connection element 3_{10A}, fits within a 20 mm square whereas the antenna 4_{9A} only fits within an 108 mm square. The smallness of area results from the presence of many small segments forming the FIG. 10A and FIG. 10B antennas, that is, the FIG. 10A and FIG. 10B antennas have a high segment count with many of the connecting segments reversing direction.

FIG. 11A depicts a top view of a reduced segment count snowflake-shaped loop antenna 4_{11A} having a radiation length of about 337 mm which is the same length as the length of the FIG. 9A antenna. The number of segments (about 280 segments) forming the antenna of FIG. 11A is substantially less than the number of segments forming the antenna of FIG. 10A. While this reduction of segments increases the area covered by the antenna of FIG. 11A relative to the antenna of FIG. 10A, the area is still much less than the area of the antenna of FIG. 9A. The scale of the FIG. 10A and FIG. 11A antennas in the sheet of drawing is the same.

FIG. 11B depicts a top view of a reduced segment count snowflake-shaped loop antenna 4_{11B} having a radiation length of about 150 mm which is the same length as the length of the FIG. 9B and FIG. 9C antennas. The number of segments forming the antenna of FIG. 11B is substantially less than the number of segments forming the antenna of FIG. 10B. While this reduction in the number of segments increases the area covered by the antenna of FIG. 11 B relative to the antenna of FIG. 10B, the area is still much less than the areas of the antennas of FIG. 9B and FIG. 9C. The scale of the FIG. 10B and FIG. 11B antennas in the drawing is the same.

FIG. 11C depicts a top view of a reduced segment count snowflake-shaped loop antenna 4_{11C} having a radiation length of about 150.4 mm and a line width of approximately 0.05 mm together with contact elements 3_{11C}. The impedance of antenna 4_{11C} is approximately 50 ohms and hence can be connected to a 50 ohm transceiver unit, such as transceiver unit 15-1 in FIG. 14, without need for matching. Accordingly, the contact pad elements 3_{11C} are connection means that provide adequate coupling (physical connector, capacitive, inductive or other coupling), without the addition of a printed transmission line or other matching element, in the connecting element 15-2 of FIG. 14. The different segments of antennas 4_{11A}, 4_{11B} and 4_{11C} connect at vertices and conduct electrical current in different directions near the vertices.

FIG. 12A depicts a top view of a koch island fractal-shaped loop antenna 4_{12A} having a radiation length of about 337 mm which is the same length as the length of the FIG. 9A antenna. The antenna 4_{12A} has a transmission line matching element 3_{12A} which is not necessarily drawn to scale for matching the impedance of the antenna loop.

FIG. 12B depicts a top view of a koch island fractal-shaped loop antenna having a radiation length of about 150 mm which is the same length as the length of the FIG. 9B and FIG. 9C antennas. The antenna 4_{12B} has a transmission line matching element 3_{12B} which is not necessarily drawn to scale for matching the impedance of the antenna loop. The different segments of antennas 4_{12A} and 4_{12B} connect at vertices and conduct electrical current in different directions near the vertices.

FIG. 13 depicts a the device of FIG. 1 juxtaposed a person's head at the ear. The arrayed-segment antennas described have low SAR values and hence tend to reduce adsorbed near field radiation.

a=radius of transmission line (approximately a flat strip of 0.7 mm by 0.036 mm)

ε,=dielectric constant of substrate

For a substrate where the dielectric constant, ε, is 2.5 and the impedance Z_{TL}, is 80.62 ohms, then the FIG. 9C antenna example described has D=1.0 mm and a=0.35 mm.

The spacing, S_{TL}, between transmission line conductors of 0.3 mm is given approximately by the following equation:

S_{TL}=D−2a

FIG. 15 depicts a perspective view of a 2-D representation of the far field model data (in elevation along the Y-axis) for, and superimposed over, the arrayed-segment antenna of FIG. 9C.

FIG. 16 depicts a perspective view of a 2-D representation of the far field model data (in elevation along the Y-axis) for, and superimposed over, the arrayed-segment antenna of FIG. 12B.

FIG. 17 depicts a perspective view of a 3-D representation of the far field model data (in elevation along the Y-axis) for the arrayed-segment antenna of FIG. 9C.

FIG. 18 depicts a perspective view of a 3-D representation of the far field model data (in elevation along the Y-axis) for the arrayed-segment antenna of FIG. 12B.

FIG. 19 depicts a view of a 2-D representation of a slice of the FIG. 17 data in the YZ-plane.

FIG. 20 depicts a view of a 2-D representation of a slice of the FIG. 18 data in the YZ-plane.

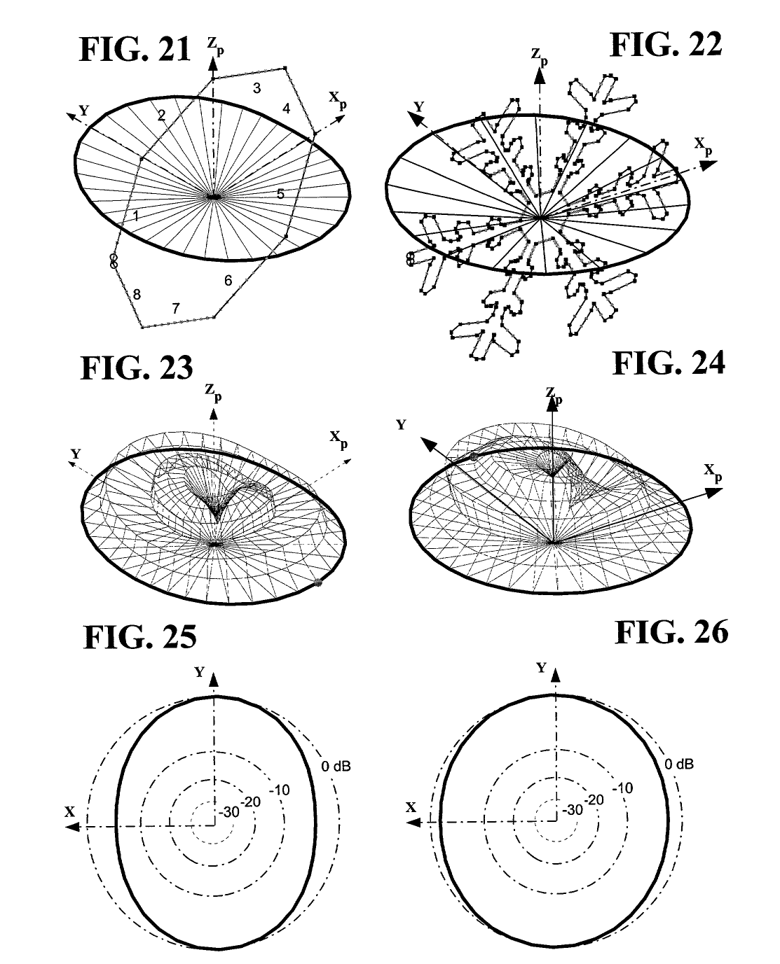

FIG. 21 depicts a perspective view of a 2-D representation of the far field model data (in the XₚZₚ-plane) for, and superimposed over, the arrayed-segment antenna of FIG. 9C.

FIG. 22 depicts a perspective view of a 2-D representation of the far field model data (in the XₚZₚ-plane) for, and superimposed over, the arrayed-segment antenna of FIG. 12B.

FIG. 23 depicts a perspective view of a 3-D representation of the far field model data (in the XₚY-plane highlighted) for the arrayed-segment antenna of FIG. 9C.

FIG. 24 depicts a perspective view of a 2-D representation of the far field model data (in the XₚY-plane highlighted) for the arrayed-segment antenna of FIG. 12B

FIG. 25 depicts a view of a 2-D representation of the far field model data of FIG. 23.

FIG. 26 depicts a view of a 2-D representation of the far field model data of FIG. 24.

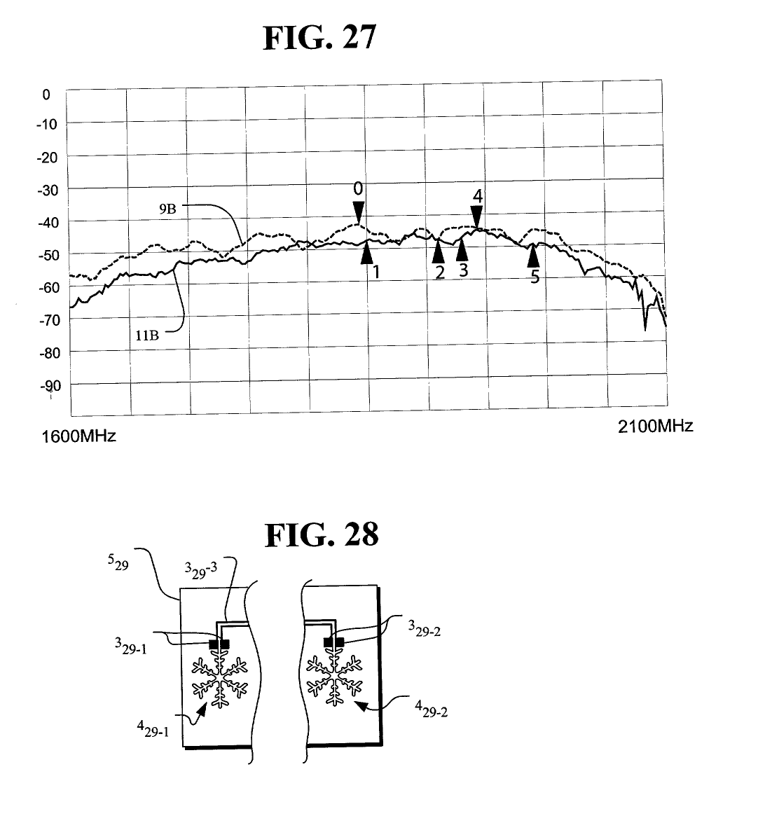

DIG. 27 depicts an HP Network analyzer plot of the Log₁₀ magnitude of the far field (measured at 10 meters) of simplified snowflake antenna of FIG. 11B and circle/octagon loop antennas and FIG. 9C. Data extracted from FIG. 27 is presented for comparison in the following TABLE 1. Note in TABLE 2 that the simplified snowflake segmented-array antenna of FIG. 11B has essentially the same good performance as the circle/octagon loop antennas of FIG. 9B and FIG. 9C

TABLE 1

| | FREQUENCY | log MAG-9B | log MAG-11B |
|---|---|---|---|
| 0 | 1842.500000 MHz | | −42.652 dB |
| 1 | 1850 MHz | −47.279 dB | −44.111 dB |
| 2 | 1910 MHz | −47.402 dB | −47.425 dB |
| 3 | 1930 MHz | −46.863 dB | −43.956 dB |
| 4 | 1943.000033 MHz | −44.807 dB | |
| 5 | 1990 MHz | −49.256 dB | −45.134 dB |

sources, as distinguished from the one or two point sources found on linear antennas (for example, two vertices on dipole antennas). In the arrayed-segment antennas, SAR measured over a small area is reduced while the antenna's far-field gain is not significantly affected because the many point sources spread the radiation over a relatively larger area.

FIG. 28 depicts a top view of reduced segment count snowflake-shaped loop antennas 4₂₉-1 and 4₂₉-2 on a common substrate 5₂₉, each having a radiation length of about 150.4 mm and a line width of approximately 0.05 mm, together with contact elements 3₂₉-1 and 3₂₉-1, respectively. The contact elements 3₂₉-1 and 3₂₉-1 are connected together, or are separately connected, to the transceiver unit 15-1 of FIG. 14 through a common connecting element 15-2 or through separate connecting elements of the element 15-2 type. The loop antennas 4₂₉-1 and 4₂₉-2 are like the antenna 4_{11C} of FIG. 11C. While FIG. 28 explicitly depicts two snowflake-shaped loop antennas 4₂₉-1 and 4₂₉-2, any number of loops may be included on the same or different substrates for inclusion in the same communication device.

While the invention has been particularly shown and described with reference to preferred embodiments thereof it will be understood by those skilled in the art that various changes in form and details may be made therein without departing from the scope of the invention.

1. A loop antenna, for use with a communication device, operating for exchanging energy at a radiation frequency, comprising,
connection means having first and second conductors for conduction of electrical current,
a radiation loop including a plurality of electrically conducting segments each having a segment length where,
said segments are electrically connected in series between said first and second conductors for exchange of energy at the radiation frequency, said loop having an electrical length, A, that is proportional to the sum of segment lengths for each of said radiation segments,
said segments are arrayed in a pattern so that different segments connect at vertices and conduct electrical current in different directions near said vertices.

2. The loop antenna of claim 1 wherein said connection means is a transmission line for non-radiation conduction.

3. The loop antenna of claim 1 wherein said segments are arrayed in multiple divergent directions that tend to increase the loop antenna electrical length while permitting the overall outside dimensions of said loop antenna to fit within an antenna area of said communication device.

4. The loop antenna of claim 1 wherein said connection means includes contact areas for coupling to a transceiver of said communication device.

5. The loop antenna of claim 1 wherein said radiation loop has one impedance value and said transmission line has a compensating impedance value whereby the combined impedance value of the loop antenna equals a predetermined impedance value.

6. The loop antenna of claim 1 wherein said predetermined impedance value is 50 ohms.

7. The loop antenna of claim 1 wherein said radiation loop has a loop impedance value equal to a predetermined impedance value.

8. The loop antenna of claim 7 wherein said predetermined impedance value is 50 ohms.

9. The loop antenna of claim 1 wherein said radiation loop has an irregular shape wherein said segments are arrayed with no particular regular pattern.

10. The loop antenna of claim 1 wherein said radiation loop has snowflake shape wherein said segments are arrayed in a snowflake pattern.

11. The loop antenna of claim 10 wherein said snowflake pattern is formed of approximately 280 of said segments.

12. The loop antenna of claim 1 wherein said segments include straight and curved segments.

13. The loop antenna of claim 1 wherein said segments are formed of a conductor on a flexible plastic substrate.

14. The loop antenna of claim 1 wherein said connection means is a transmission line for non-radiation conduction and wherein said segments and said transmission line are formed of conductors on a flexible plastic substrate.

15. The loop antenna of claim 1 wherein said radiation loop transmits and receives radiation.

16. The loop antenna of claim 15 wherein said radiation loop transmits and receives radiation in the US PCS band.

17. The loop antenna of claim 15 wherein said radiation loop transmits and receives radiation in the US Cellular band.

18. The loop antenna of claim 15 wherein said radiation loop transmits and receives radiation in the small communication device spectrum.

19. A loop antenna, for use with a communication device, operating for exchanging energy at one or more radiation frequencies, comprising,
connection means having conductors for coupling of electrical current,
a plurality of radiation loops, each of said loops including a plurality of electrically conducting segments each having a segment length where,
said segments are electrically connected in series between said first and second ones of said conductors for exchange of energy at one of said radiation frequencies, said loop having an electrical length, Aₜ that is proportional to the sum of segment lengths for each of said radiation segments,
said segments are arrayed in a pattern so that different segments connect at vertices and conduct electrical current in different directions near said vertices.

20. A loop antenna, for use with a communication device having an antenna area, for exchanging energy at a radiation frequency, comprising,
a transmission line having first and second conductors for non-radiating conduction of electrical current,
a plurality of electrically conducting segments each having a segment length where,
said segments are connected in series to form a loop electrically connected between said first and second conductors where said loop has an electrical length, Aₜ that is proportional to the sum of segment lengths for each of said segments and that facilitates exchange of energy at the radiation frequency, and where said loop is represented by a virtual circle of radius R₂ having a perimeter length equal to π(2R₂) that defines a virtual maximum enclosed area of π(R₂)²,
said segments are arrayed in a pattern that has an enclosed area of π(R₁)² that is represented by a circle of perimeter equal to π(2R₁) that defines a virtual enclosed area of π(R₁)² where R₁ is substantially less than R₂ and the virtual enclosed area of π(R₁)² is substantially less than the virtual maximum enclosed area of λ(R₁)² but where the electrical length electrical length, Aₜ, is approximately equal to π(2R₂).

21. A loop antenna, for use with a communication device having an antenna area, for exchanging energy at a radiation frequency, comprising,
a base for supporting said antenna within said antenna area,
a transmission line mounted on said base and having first and second conductors for non-radiating conduction of electrical current,
a plurality of electrically conducting segments mounted on said base, each segment having a segment length where,
said segments are connected in series to form a loop electrically connected between said first and second conductors where said loop has an electrical length, Aₜ that is proportional to the sum of segment lengths for each of said segments and that facilitates exchange of energy at the radiation frequency, and where said loop is represented by a virtual circle of radius R₂ having a perimeter length equal to π(2R₂) that defines a virtual maximum enclosed area of π(R₂)²,
said segments are arrayed in a pattern that has an enclosed area of π(R₁)² that is represented by a circle of perimeter equal to π(2R₁) that defines a virtual enclosed area of π(R₁)² where R₁ is substantially less than R₂ and the virtual enclosed area of π(R₁)² is substantially less than the virtual maximum enclosed area of π(R₁)² but where the electrical length electrical length, Aₜ, is approximately equal to π(2R₂).

22. A loop antenna, for use with a communication device having an antenna area, for exchanging energy at a radiation frequency, comprising,
a base for supporting said antenna within said antenna area,
a transmission line mounted on said base and having first and second conductors for non-radiating conduction of electrical current,
a plurality of electrically conducting segments mounted on said base, each segment having a segment length where,
said segments are connected in series to form a loop electrically connected between said first and second conductors where said loop has an electrical length, Aₜ that is proportional to the sum of segment lengths for each of said segments and that facilitates exchange of energy at the radiation frequency, and where said loop is represented by a virtual circle of radius R₂ having a perimeter length equal to π(2R₂) that defines a virtual maximum enclosed area of π(R₂)²,
said segments are arrayed in a pattern that has an enclosed area of π(R₁)² that is represented by a circle of perimeter equal to π(2R₁) that defines a virtual enclosed area of π(R₁)² where R₁ is substantially less than R₂ and the virtual enclosed area of π(R₁)² is substantially less than the virtual maximum enclosed area of π(R₁)² but where the electrical length electrical length, Aₜ, is approximately equal to π(2R₂), said segments arrayed to reduce the E field magnitude whereby low SAR is achieved in said particular direction.
